(19) United States
(12) Patent Application Publication
(10) Pub. No.: US 2024/0195193 A1
(43) Pub. Date: Jun. 13, 2024

(54) POWER SOURCE DEVICE AND ELECTRONIC APPARATUS

(71) Applicant: SONY GROUP CORPORATION, TOKYO (JP)

(72) Inventor: KENTA ASAKURA, TOKYO (JP)

(21) Appl. No.: 18/551,315

(22) PCT Filed: Mar. 30, 2021
(86) PCT No.: PCT/JP2021/013642

§ 371 Date: Sep. 19, 2023

(51) Int. Cl. H02J 7/00

(52) U.S. Cl. CPC H02J 7/0025; H02J 7/0048; H02J 7/0063

(57) ABSTRACT

A power source device according to an embodiment of the present technology includes: a plurality of holding units; and a power control unit. Each of the plurality of holding units attachably/detachably holds a battery. The power control unit selects, on the basis of a state of each of a plurality of batteries held by the plurality of holding units, a power supply battery to be used for power supply. Further, the power source device is configured such that another battery that has not been selected as the power supply battery is attachable/detachable to/from the holding unit while power supply by the power supply battery is maintained.

### TECHNICAL FIELD

The present technology relates to a power source device and an electronic apparatus including the power source device.

### BACKGROUND ART

Patent Literature 1 discloses a mobile terminal apparatus including a battery that can be detached by a user and a sub-battery that cannot be detached (paragraphs [0009] to [0012] of the specification, FIG. 1, and the like of Patent Literature 1).

### CITATION LIST

### Patent Literature

Patent Literature 1: Japanese Patent Application Laid-open No. 2020-112986

### DISCLOSURE OF INVENTION

### Technical Problem

There is a demand for a technology that enables efficient charging of a power source device.

In view of the circumstances as described above, it is an object of the present technology to provide a power source device and an electronic apparatus that enable efficient charging.

### Solution to Problem

In order to achieve the above-mentioned object, a power source device according to an embodiment of the present technology includes: a plurality of holding units; and a power control unit.

Each of the plurality of holding units attachably/detachably holds a battery.

The power control unit selects, on the basis of a state of each of a plurality of batteries held by the plurality of holding units, a power supply battery to be used for power supply.

Further, the power source device is configured such that another battery that has not been selected as the power supply battery is attachable/detachable to/from the holding unit while power supply by the power supply battery is maintained.

In this power source device, a power supply battery to be used for power supply is selected on the basis of a state of each of a plurality of batteries attachably/detachably held by a plurality of holding units. Further, another battery that has not been selected as the power supply battery is attachable/detachable to/from the holding unit while power supply by the power supply battery is maintained. This enables efficient charging.

Each of the plurality of holding units may be configured such that the battery is attachable/detachable by a user.

The power control unit may select, as the power supply battery, a battery having the lowest remaining amount, among the plurality of batteries held by the plurality of holding units.

The power control unit may detect a state of each of the plurality of batteries held by the plurality of holding units.

The power control unit may detect at least one of a remaining amount of a battery, a decrease in the remaining amount of the battery, a temperature of the battery, or presence or absence of power supply by the battery.

The power control unit may detect whether or not a battery is held for each of the plurality of holding units.

The power source device may further include a notification unit that notifies a user of a state of each of the plurality of batteries held by the plurality of holding units.

The notification unit may notify a user of whether or not a battery is held for each of the plurality of holding units.

The power control unit may control power supply by the selected power supply battery.

The power control unit may select a plurality of power supply batteries. In this case, the power control unit may control a speed of power supply of each of the plurality of power supply batteries.

The power control unit may control speeds of power supply by the plurality of power supply batteries to be the same speed.

The power control unit may select a plurality of power supply batteries. In this case, the power control unit may control power supply such that remaining amounts of the plurality of power supply batteries are the same.

The power control unit may stop power supply by the power supply battery whose remaining amount is less than a predetermined threshold value.

The power control unit may select a plurality of power supply batteries. In this case, the power control unit may switch, in a case where a remaining amount of each of the plurality of power supply batteries is less than a predetermined threshold value, the power supply battery to another battery whose remaining amount is larger than the predetermined threshold value.

The power control unit may select a plurality of power supply batteries. In this case, the power control unit may execute, in a case where a remaining amount of each of the plurality of power supply batteries is less than a predetermined threshold value and there is no battery whose remaining amount is larger than the predetermined threshold value, power supply by the plurality of batteries held by the plurality of holding units.

The power control unit may be configured to be capable of exchanging power among the plurality of batteries held by the plurality of holding units.

The power control unit may concentrate power to one battery among the plurality of batteries held by the plurality of holding units.

The power control unit may control charging of each of the plurality of batteries held by the plurality of holding units.

The power control unit may restrict, in a case where the battery is held by only one holding unit among the plurality of holding units, detachment of the battery from the one holding unit.

An electronic apparatus according to an embodiment of the present technology includes: the plurality of holding units; the power control unit; and a functional part unit.

The functional part unit operates by power supply from the power supply battery.

Further, the electronic apparatus is configured such that another battery that has not been selected as the power supply battery is attachable/detachable to/from the holding unit while power supply by the power supply battery is maintained.

### BRIEF DESCRIPTION OF DRAWINGS

FIG. 1 is a schematic diagram showing a configuration example of a power source device according to an embodiment of the present technology.

FIG. 2 is a schematic diagram showing a configuration example of a power source device according to the embodiment of the present technology.

FIG. 3 is a schematic diagram showing a configuration example of a power source device according to the embodiment of the present technology.

FIG. 4 is a schematic diagram showing a configuration example of a power source device according to the embodiment of the present technology.

FIG. 5 is a schematic diagram showing a mobile terminal in which the power source device is built.

FIG. 6 is a schematic diagram showing the mobile terminal in which the power source device is built.

FIG. 7 is a flowchart showing an example of processing relating to power supply.

FIG. 8 is a schematic diagram showing an example of the state of a battery in the mobile terminal.

FIG. 9 is a schematic diagram showing an example of the state of a battery in the mobile terminal.

FIG. 10 is a schematic diagram showing an example of the state of a battery in the mobile terminal.

FIG. 11 is a schematic diagram showing an example of an electronic apparatus to which the power source device can be applied.

### MODE(S) FOR CARRYING OUT THE INVENTION

Hereinafter, an embodiment according to the present technology will be described with reference to the drawings.

### [Power Source Device]

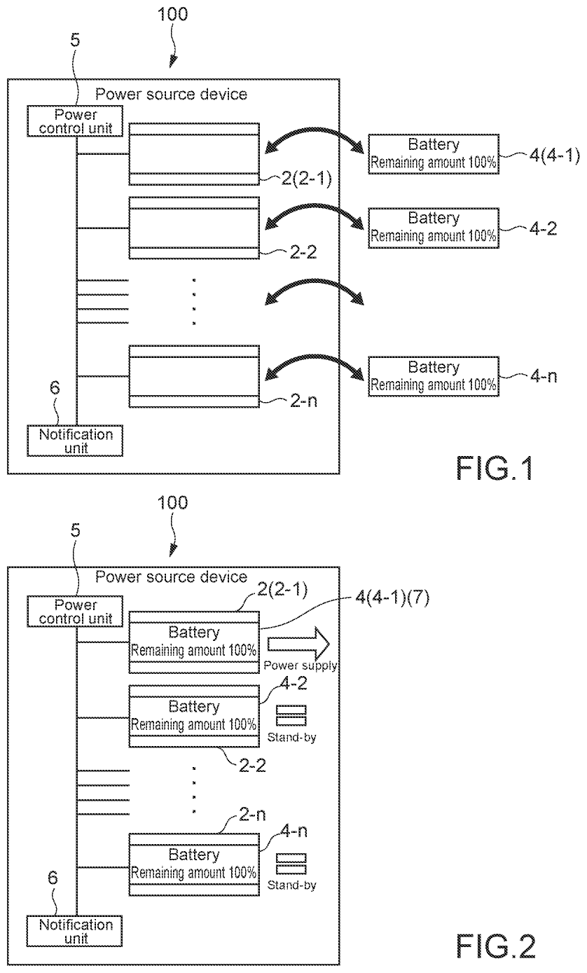

FIG. 1 to FIG. 4 are each a schematic diagram showing a configuration example of a power source device according to an embodiment of the present technology.

A power source device 100 is capable of supplying electric power (power supply) to an electronic apparatus and the like.

For example, the power source device 100 is connected to an electronic apparatus via a cable or the like. The power source device 100 supplies electric power to the electronic apparatus via the cable or the like.

The present technology is not limited thereto, and the power source device 100 may be built in the electronic apparatus or the like. In this case, the power source device 100 configured in a form that can be used by itself may be installed inside the electronic apparatus.

Alternatively, the power source device 100 and the electronic apparatus may be integrally formed. That is, each of one or more components (e.g., a plurality of holding units 2, a power control unit 5, and the like shown in FIG. 1) constituting the power source device 100 according to the present technology may be integrally formed with the electronic apparatus.

In the case where the power source device 100 is built in the electronic apparatus, the power source device 100 can be regarded as one component constituting the electronic apparatus, such as a power source unit of the electronic apparatus.

As shown in FIG. 1 to FIG. 4, the power source device 100 includes a plurality of holding units 2, a notification unit 6, and a power control unit 5.

The plurality of holding units 2, the notification unit 6, and the power control unit 5 are electrically connected to each other via a wire, a circuit, or the like.

As shown in FIG. 1, each of the plurality of holding units 2 attachably/detachably holds a battery 4. That is, each of the plurality of holding units 2 is configured such that a user who uses the power source device 100 and the electronic apparatus can attach and detach the battery 4.

Examples of the specific configuration of the holding unit 2 include a configuration in which a recessed portion in which the battery 4 can be installed is formed and the battery 4 is attachable/detachable to/from the recessed portion by operating a lock mechanism such as a slide lock.

In addition, in another configuration, the battery 4 is attachable/detachable to/from the recessed portion by the operation of screwing and unscrewing using a screwdriver or the like that is generally available to a user.

In addition, an arbitrary configuration in which the battery 4 is attachable/detachable by a user who uses the power source device 100 or the electronic apparatus may be adopted. Further, the configurations of the plurality of holding units 2 may be the same as or different from each other.

Meanwhile, for example, a configuration in which a user cannot attach/detach the battery 4, such as a configuration in which the battery 4 cannot be attached/detached, a configuration in which the battery 4 is attached/detached using a special tool that is difficult for the user to obtain, and a configuration in which the battery 4 is attachable/detachable only at a factory or the like in which the power source device 100 or the electronic apparatus is produced, is not adopted.

In this embodiment, as the holding unit 2, a total of n holding units 2 of a holding unit 2-1 to a holding unit 2-n are formed. The holding unit 2-1 to the holding unit 2-n attachably/detachably hold a battery 4-1 to a battery 4-n, respectively.

In the case of supplying power to the electronic apparatus or the like, the batteries 4 are mounted on the plurality of holding units 2. Then, electric power in the batteries 4 held by the plurality of holding units 2 is supplied to the electronic apparatus or the like.

Note that in applying the present technology, the number of holding units 2 is not limited and an arbitrary number of two or more may be adopted. Further, the holding unit 2 is called by another name such as a mounting portion of the battery 4 and a mounting port of the battery 4 in some cases.

As the battery 4, a rechargeable battery such as a lithium ion battery and an all-solid battery is used.

For example, the lithium ion battery exhibits excellent performance when used at a high temperature. In this way, the type of battery 4 may be appropriately determined in accordance with the application and usage conditions of the power source device 100.

It goes without saying that the type of battery 4 to be inserted into the holding unit 2 is not limited. Further, as the battery 4, a non-rechargeable battery may be inserted.

The notification unit 6 is capable of notifying a user of the state of each of the plurality of batteries 4 held by the plurality of holding units 2.

The form of notification of information to the user is not limited. For example, an arbitrary form such as displaying an image by a display and outputting audio by a speaker or the like may be adopted. That is, as the notification unit 6, a display, a speaker, or the like can be used. It goes without saying that another device may be sued.

Examples of the state of the battery 4 include the remaining amount of the battery 4, the decrease in the remaining amount of the battery 4, the temperature of the battery 4, and the presence or absence of power supply by the battery 4. For example, at least one of these pieces of information is notified. It goes without saying that other information may be notified as the state of the battery 4.

Further, the notification unit 6 is capable of notifying a user of whether or not the battery 4 is held for each of the plurality of holding units 2.

For example, in the example shown in FIG. 1, the notification unit 6 notifies that the battery 4 is not mounted on any of the holding units 2.

In the example shown in FIG. 2, it is notified that the battery 4 is mounted on all the holding units 2. Further, information indicating that power supply is performed by the battery 4-1 held by the holding unit 2-1 (power supply) and power supply by the other batteries 4-2 to 4-n is not performed (no power supply) is notified.

In addition, various types of information such as the remaining amount of electric power in each of the batteries 4, how much the remaining amount has decreased, and the temperature of the battery 4 may be notified.

The power control unit 5 includes hardware necessary for configurating a computer, such as a processor such as a CPU, a GPU, and a DSP, a memory such as a ROM and a RAM, and a storage device such as an HDD. For example, the CPU or the like loads a program according to the present technology recorded on the ROM or the like into the RAM and executes the program, thereby performing an operation such as power supply by the power source device 100.

The configuration of the power control unit 5 is not limited, and arbitrary hardware and arbitrary software may be used. It goes without saying that hardware such as FPGA and ASIC may be used. Further, the position where each piece of hardware is configured is not limited and may be arbitrarily designed.

The power control unit 5 controls the power supply by the plurality of batteries 4 held by the plurality of holding units 2.

In this embodiment, the power control unit 5 selects, on the basis of the state of each of the plurality of batteries 4 held by the plurality of holding units 2, a power supply battery 7 to be used for power supply. Then, the power supply by the selected power supply battery 7 is controlled.

In the example shown in FIG. 2, the battery 4-1 held by the holding unit 2-1 is selected as the power supply battery 7. Then, the power supply battery 7 performs power supply. The other batteries 4-2 to 4-n are not selected as the power supply battery 7 and are in a stand-by state.

As illustrated in FIG. 2, only one battery 4 among the plurality of batteries 4 held by the plurality of holding units 2 may be selected as the power supply battery 7. The present technology is not limited thereto, and a plurality of batteries 4 may be selected as power supply batteries 7. It goes without saying that all the batteries 4 may be selected as power supply batteries 7.

Note that in this embodiment, the power control unit 5 detects the state of each of the plurality of batteries 4 held by the plurality of holding units 2.

That is, the power control unit 5 detects the remaining amount of the battery 4, the decrease in the remaining amount of the battery 4, the temperature of the battery 4, the presence or absence of power supply by the battery 4, and the like. One of these pieces of information may be detectable or all the pieces of information may be detachable. It goes without saying that as the state of the battery 4, other information may be detected.

Further, the power control unit 5 detects whether or not the battery 4 is held for each of the plurality of holding units 2.

The method, mechanism, and the like for detecting the state of the battery 4 and whether or not the battery 4 is held are not limited, and an arbitrary method, an arbitrary mechanism, and the like may be used. For example, it is also possible to detect the state of the battery 4 and whether or not the battery 4 is held by using a well-known technology.

In this embodiment, the notification unit 6 notifies the state of the battery 4 and whether or not the battery 4 is held, which are detected by the power control unit 5.

Further, in this embodiment, the power control unit 5 controls charging of each of the plurality of batteries 4 held by the plurality of holding units 2.

For example, electric power is supplied from an external power source to the power source device 100 via a charging adaptor or the like. The power control unit 5 charges the plurality of batteries 4 held by the plurality of holding units 2 with the supplied electric power.

### [Hot Swapping]

This power source device 100 is configured such that the other batteries 4 that have not been selected as the power supply battery 7 are attachable/detachable to/from the holding units 2 while power supply by the power supply battery 7 is maintained.

Such a device mechanism is called hot swapping. The hot swapping is a mechanism of a device having a structure in which mechanisms included in the device can be attached/detached while maintaining the function of the device.

This power source device 100 has a configuration in which a mechanism (battery 4) can be attached/detached while maintaining the function of the device (power supply) and is configured as a hot-swappable device.

Note that a specific configuration for enabling hot swapping of the battery 4 is not limited and an arbitrary configuration may be adopted. For example, it can be realized using a well-known technology.

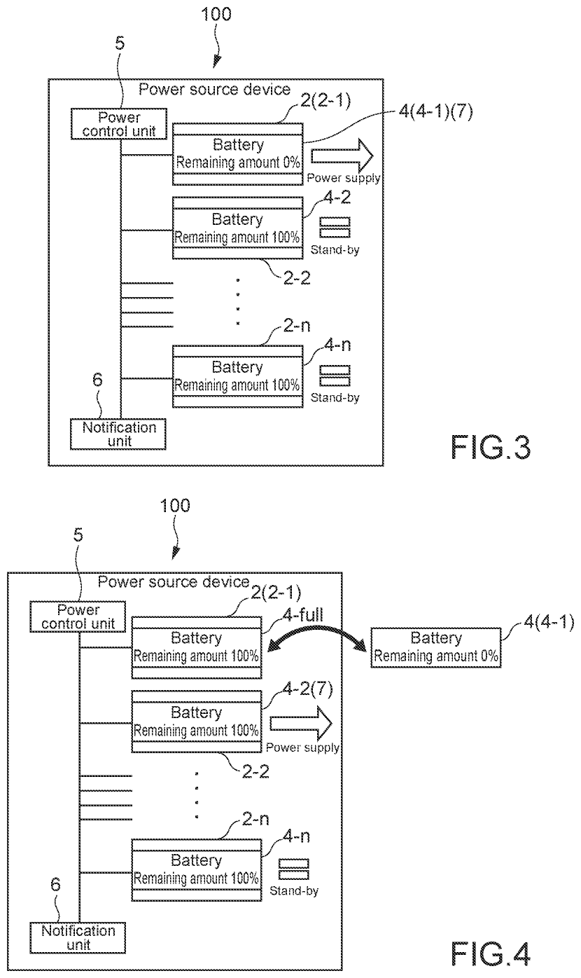

As shown in FIG. 3, assumption is made that the power supply by the power supply battery 7 (battery 4-1) held by the holding unit 2-1 progresses and the remaining amount of the battery 4-1 becomes 0%.

As shown in FIG. 4, the power control unit 5 selects the battery 4-2 held by the holding unit 2-2 as the power supply battery 7. That is, the power supply battery 7 is switched from the battery 4-1 to the battery 4-2. This switching operation is executed without stopping power supply. That is, the power supply to the electronic apparatus or the like is maintained.

Note that the switching operation may be executed in the case where the remaining amount of the power supply battery 7 is low (e.g., 5%). That is, the switching operation may be executed before the remaining amount of the power supply battery 7 becomes 0%.

The notification unit 6 notifies that the remaining amount of the battery 4 held by the holding unit 2 is low. Note that the fact that the power supply battery 7 has been switched to another battery 4 may be notified in addition thereto.

In this power source device 100, the battery 4 is attachable/detachable to/from the holding unit 2 by a user.

Further, this power source device 100 is capable of hot-swapping the battery 4. That is, the power source device 100 is configured such that the other batteries 4 that have not been selected as the power supply battery 7 are attachable/detachable to/from the holding unit 2 while power supply by the power supply battery 7 is maintained.

That is, in the example shown in FIG. 4, a user can detach the battery 4-1 whose remaining amount is low from the holding unit 2-1 while power supply by the newly selected power supply battery 7 (battery 4-2) is maintained. Further, the user can attach a fully charged battery 4-full (whose remaining amount is 100%) to the holding unit 2-1.

That is, the user can replace the battery 4-1 whose remaining amount is low with the fully charged battery 4-full while the power supply is maintained.

This realizes pseudo-instantaneous charging and enables very efficient charging.

### [Electronic Apparatus (Mobile Terminal)]

An example of an electronic apparatus in which this power source device 100 is built will be described.

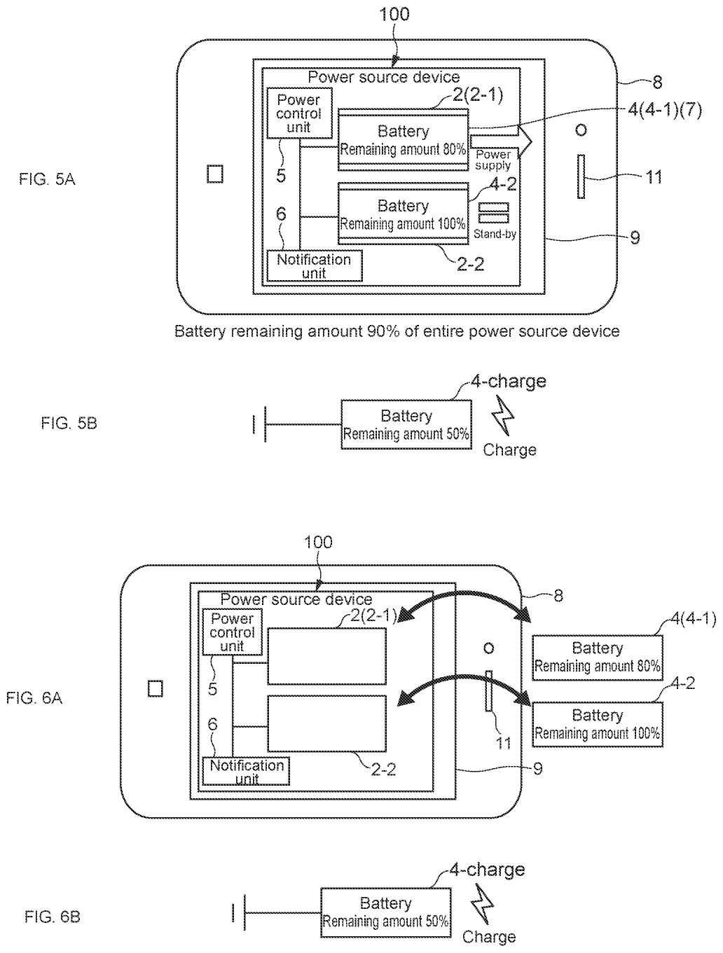

FIG. 5 an FIG. 6 are each a schematic diagram showing a mobile terminal 8 in which the power source device 100 is built. The power source device 100 can be regarded as a component that functions as a power source unit of the mobile terminal 8.

Part A of FIG. 5 and Part A of FIG. 6 illustrate the mobile terminal 8.

Part B of FIG. 5 and Part B of FIG. 6 illustrate a battery 4-charge being charged externally.

The mobile terminal 8 corresponds to an embodiment of an electronic apparatus according to the present technology.

The mobile terminal 8 includes a touch panel 9, a speaker 11, and the power source device 100.

The touch panel 9 functions as a display unit capable of displaying various images and various GUIs (Graphical User Interface). Further, the touch panel 9 functions as an operation input unit for inputting a user's operation.

A user of the mobile terminal 8 can use the mobile terminal 8 by operating the touch panel 9 while checking the information displayed on the touch panel 9.

In this embodiment, the touch panel 9 and the speaker 11 function as the notification unit 6 illustrated in FIG. 1 and the like.

It goes without saying that another arbitrary configuration may be adopted as the display unit and the operation input unit.

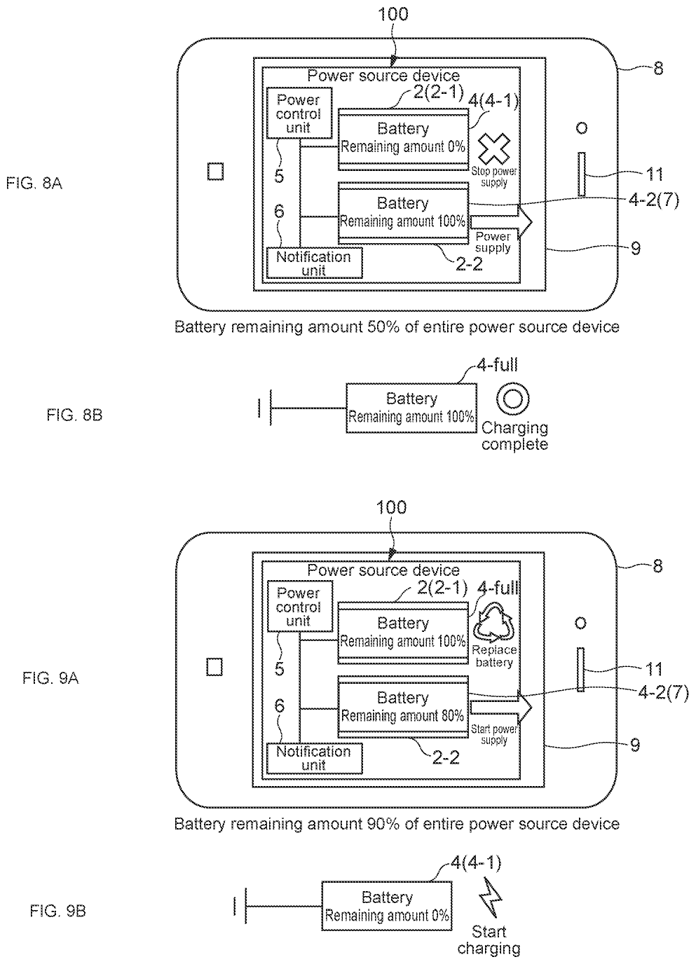

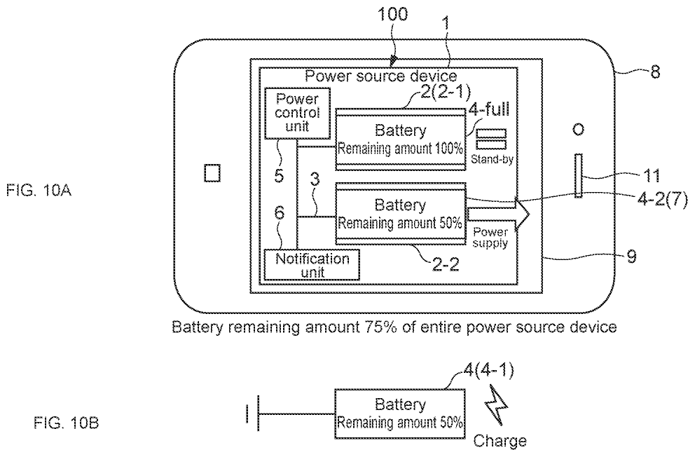

In Part A of FIG. 5 and Part A of FIG. 6, the configuration of the power source device 100 is illustrated within the touch panel 9. This shows the internal configuration of the mobile terminal 8 and does not show the image displayed on the touch panel 9. The same applies to Part A of FIG. 8, Part A of FIG. 9, and Part A of FIG. 10.

In the mobile terminal 8 according to this embodiment, two holding units 2 of the holding unit 2-1 and the holding unit 2-2 are formed as the plurality of holding units 2.

A user can attach/detach the battery 4 to/from each of the two holding units 2 (the holding unit 2-1 and the holding unit 2-2).

The touch panel 9, the speaker 11, and the like of the mobile terminal 8 correspond to an embodiment of a functional part unit according to an embodiment that operates by power supply from the power supply battery 7.

The specific configuration of the mobile terminal 8 is not limited. For example, a microphone, a camera, a communication unit, a storage unit, and the like may be configured.

In this case, these components can also be regarded as an embodiment of the functional part unit according to the present technology.

As shown in FIG. 5, the average battery remaining amount of the batteries 4 installed in the respective holding units 2 can be regarded as the battery remaining amount of the entire power source device 100.

In the example shown in FIG. 5, the battery 4-1 whose battery remaining amount is 80% is inserted into the holding unit 2-1. Further, the battery 4-2 whose battery remaining amount is 100% is inserted into the holding unit 2-2. Therefore, the battery remaining amount of the entire power source device 100 is 90%.

Also in the case where three or more batteries 4 are installed, similarly, the average battery remaining amount of the respective batteries 4 can be regarded as the battery remaining amount of the entire power source device 100. Further, in the case where only one battery 4 is installed, the battery remaining amount of this battery 4 can be regarded as the battery remaining amount of the entire power source device 100.

Part B of FIG. 5 and Part B of FIG. 6 schematically illustrate the battery 4-charge being charged.

For example, the battery 4-charge is connected to a power source to perform charging. Specifically, for example, the battery 4-charge is placed on a dedicated charger, and a cable of the charger is connected to a household outlet. As a result, electric power is supplied to the battery 4-charge to realize the charging of the battery 4-charge.

Although the remaining amount of the battery 4-charge being charged shown in FIG. 5 and FIG. 6 is 50%, the remaining amount naturally increases with the charging and eventually reaches full charge (remaining amount of 100%).

A user can increase the battery remaining amount of the entire power source device 100 by replacing the battery 4 whose remaining amount has been exhausted in the power source device 100 with the battery 4 whose remaining amount has sufficiently increased by charging.

### [Power Supply Operation]

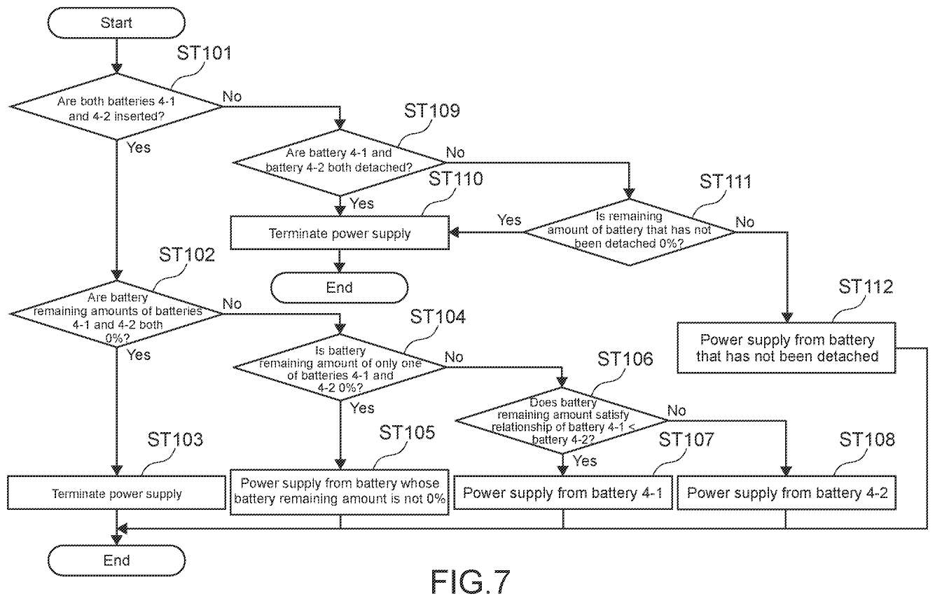

FIG. 7 is a flowchart showing an example of a power supply operation by the power source device 100.

In this embodiment, the power control unit 5 executes the processing shown in FIG. 7 at a predetermined frame rate (e.g., every second).

It goes without saying that the frame rate at which the processing is executed is not limited. Further, for example, the processing may be started with a predetermined event such as when the battery 4 is attached/detached as a trigger.

Hereinafter, when describing a plurality of batteries 4 such as the battery 4-1 and the battery 4-2, the notation such as “the batteries 4-1 and 4-2” will be used in some cases.

Whether or not both the batteries 4-1 and 4-2 are inserted into the holding units 2 is determined (Step 101).

In the case where both the batteries 4-1 and 4-2 are inserted into the holding units 2 (Yes in Step 101), whether or not the battery remaining amounts of the batteries 4-1 and 4-2 are both 0% is determined (Step 102).

In the case where the battery remaining amounts of the batteries 4-1 and 4-2 are both 0% (Yes in Step 102), the battery 4 cannot supply electric power, and thus, the power supply by the power source device 100 is terminated (stopped) (Step 103).

Meanwhile, in the case where the battery remaining amounts of the batteries 4-1 and 4-2 are not both 0%, i.e., at least one of the batteries 4 has remaining power (No in Step 102), whether or not the battery remaining amount of only one of the batteries 4-1 and 4-2 is 0% is determined (Step 104).

In the case where the battery remaining amount of one battery is 0% and the battery remaining amount of the other battery is not 0% (Yes in Step 104), power supply by the battery 4 whose battery remaining amount is not 0% is executed (Step 105).

That is, the battery 4 whose battery remaining amount is not 0% is selected as the power supply battery 7 and executes power supply.

In the case where the battery remaining amounts of the two batteries 4-1 and 4-2 are both not 0%, i.e., both the batteries 4-1 and 4-2 have remaining electric power (No in Step 104), which of the battery 4-1 and the battery 4-2 has a larger battery remaining amount is determined (Step 106).

That is, in the case where in the case where the battery 4-1 has a smaller battery remaining amount (Yes in Step 106), the battery 4-1 is selected as the power supply battery 7 and executes power supply (Step 107). In the case where the battery 4-2 has a smaller battery remaining amount (No in Step 106), the battery 4-2 is selected as the power supply battery 7 and executes power supply (Step 108).

That is, of the two batteries 4-1 and 4-2, the battery 4 having a smaller battery remaining amount is selected as the power supply battery 7 and executes power supply.

Note that in the case where the battery remaining amounts of the battery 4-1 and the battery 4-2 are the same in Step 106, one of them may be selected as the power supply battery 7. For example, the battery 4 to be selected as the power supply battery 7 may be determined in advance, or the power supply battery 7 may be determined at random. Another selection method may be executed.

In the case where it is determined in the initial Step 101 that the batteries 4-1 and 4-2 are not both inserted into the holding unit 2, i.e., at least one holding unit 2 does not hold the battery 4 (No in Step 101), whether or not the battery 4-1 and the battery 4-2 are both detached from the holding units 2 is determined (Step 109).

In the case where both the batteries 4-1 and 4-2 are detached from the holding units 2 (Yes in Step 109), there is no battery 4 capable of supplying electric power, and thus, the power supply by the power source device 100 is terminated (Step 110).

Meanwhile, in the case where the batteries 4-1 and 4-2 are not both detached from the holding units 2, i.e., the battery 4 is inserted into only one holding unit 2 (No in Step 109), whether or not the remaining amount of the battery 4 is 0% is determined (Step 111).

In the case where the remaining amount of the battery 4 is 0% (Yes in Step 111), the battery 4 cannot supply electric power, and thus, the power supply by the power source device 100 is terminated (Step 110). In the case where the remaining amount of the battery 4 is not 0% (No in Step 111), i.e., the battery 4 has remaining electric power, the battery 4 is selected as the power supply battery 7 and executes power supply (Step 112).

The power supply by the power source device 100 is executed by such a series of processing.

Note that also in the case where the power source device 100 includes three or more holding units 2, the power supply can be executed by similar processing.

That is, in the case where there is no battery 4 having remaining electric power, the power supply is terminated. In the case where there is one battery 4 having remaining electric power, this battery 4 is selected as the power supply battery 7 and executes power supply. In the case where there is a plurality of batteries 4 having remaining electric power, the battery 4 having the smallest remaining amount is preferentially selected as the power supply battery 7 and executes power supply.

In this power source device 100, in the case where there is at least one battery 4 having remaining electric power, a user can replace the battery 4 whose remaining amount is 0% with the fully charged battery 4-full or the like while the power supply by the battery 4 is executed. This enables very efficient charging and realizes stable power supply.

It goes without saying that the application of the present technology is not limited to the flow as shown in FIG. 7.

In the example shown in FIG. 5, the battery 4-1 whose remaining amount is 80% and the battery 4-2 whose remaining amount is 100% are inserted into the holding units 2.

In this case, in the processing example shown in FIG. 7, the processing proceeds through the flow of Yes in Step 101, No in Step 102, No in Step 104, Yes in Step 106, and Step 107, and the battery 4-1 having a smaller battery remaining amount is selected as the power supply battery 7. Then, the power supply battery 7 executes power supply.

The battery 4-2 enters a stand-by state.

FIG. 8 to FIG. 10 are each a schematic diagram showing an example of the state of the battery 4 of the mobile terminal 8.

FIG. 8 shows the state of each of the batteries 4 after the battery 4-1 continues to execute power supply in FIG. 5.

In FIG. 8, the remaining amount of the battery 4-1 is reduced to 0% due to power supply. Further, the remaining amount of the battery 4-2 is 100%.

In this case, in this embodiment, the processing proceeds through the flow of Yes in Step 101, No in Step 102, Yes in Step 104, and Step 105, and the battery 4-2 whose battery remaining amount is not 0% is selected as the power supply battery 7. That is, the power supply battery 7 is switched from the battery 4-1 to the battery 4-2 and the power supply is maintained.

Part B of FIG. 8 schematically shows the battery 4-full that has been fully charged (remaining amount of 100%) by charging.

A user can replace the battery 4-1 whose remaining amount is 0% with the fully charged battery 4-full while the power supply by the battery 4-2 is maintained.

FIG. 9 shows the state of each of the batteries 4 in the case where the power supply by the battery 4-2 continues to be executed in FIG. 8 and the battery 4-1 placed on the holding unit 2-1 has been replaced.

In FIG. 9, the remaining amount of the battery 4-2 is reduced to 80% due to power supply. Further, the battery 4-1 whose remaining amount is 0%, which has been placed on the holding unit 2-1, is replaced with the charged battery 4-full whose remaining amount is 100%.

Immediately before the battery 4-1 is replaced, the battery 4-1 whose remaining amount is 0% has been placed on the holding unit 2-1, and the remaining amount of the battery 4-2 was 80%. That is, the battery remaining amount of the entire power source device 100 was 40%.

Meanwhile, immediately after the battery 4-1 is replaced with the battery 4-full, i.e., in FIG. 9, the remaining amount of the battery 4-full is 100% and the remaining amount of the battery 4-2 is 80%, and thus, the battery remaining amount of the entire power source device 100 is 90%.

That is, before and after the replacement of the battery 4, the battery remaining amount of the entire power source device 100 has increased by 50%. In this way, by replacing the battery 4, it is possible to momentarily increase the battery remaining amount of the entire power source device 100.

Note that although the battery 4-1 whose remaining amount is 0% is replaced with the fully charged battery 4-full in the example shown in FIG. 9, the remaining amount of each of the batteries 4 to be replaced is not limited.

For example, the battery 4 whose remaining amount is not 0% (e.g., approximately 20%) may be replaced with the fully charged battery 4-full. That is, for example, at the moment when charging of the battery 4 is completed, this fully charged battery 4-full can be inserted. As a result, the time when a charger is not used is shortened and charging can be performed efficiently.

Further, the battery 4 whose remaining amount is 0% may be replaced with the battery 4 that has not been fully charged (e.g., approximately 80%). As a result, it is possible to prevent a situation in which the remaining amounts of all the batteries 4 in the power source device 100 are 0% and the power supply is stopped.

Further, two batteries 4 may be replaced at the same time. That is, for example, the battery 4 may be replaced by detaching the battery 4-1 and the battery 4-2 at the same time and inserting two fully charged batteries 4-full.

In addition, the power supply method by the power source device 100 and the method of replacing the battery 4 are not limited, and an arbitrary method may be executed.

As shown in FIG. 9, the battery 4-2 having a smaller remaining amount executes power supply. The battery 4-full mounted on the holding unit 2-1 enters a stand-by state.

Part B of FIG. 9 schematically shows a state in which the detached battery 4-1 is charged. The electric power in the battery 4-1 increases by charging.

FIG. 10 shows the state of each of the batteries 4 in the case where the battery 4-2 continues to execute power supply.

In FIG. 10, the remaining amount of the battery 4-2 is reduced to 50% due to power supply. Further, since the power supply by the battery 4-full is not executed, the remaining amount of the battery 4-full is the same as that in FIG. 9, i.e., 100%.

Also in FIG. 10, the power supply by the battery 4-2 having a smaller a remaining amount is continuously executed.

Part B of FIG. 10 schematically shows a state in which the battery 4-1 is charged and the remaining amount is 50%.

For example, in the case where the remaining amount of the battery 4-2 is 0% due to power supply, the battery 4-2 can be replaced with the charged battery 4-1.

### [Method of Selecting Power Supply Battery]

As described above, in this embodiment, in the case where the remaining amount of one battery 4 of the two batteries 4-1 and 4-2 is 0%, the battery 4 whose remaining amount is not 0% executes power supply. Further, in the case where the remaining amounts of the batteries 4 are both not 0%, the battery 4 having the smallest remaining amount executes power supply.

That is, the battery 4 having the smallest remaining amount, of the plurality of batteries 4 held by the plurality of holding units 2, is selected as the power supply battery 7. Further, the battery 4 having the smallest remaining amount executes power supply.

As a result, it is possible to realize efficient use of the battery 4.

Specifically, for example, the three batteries 4-1, 4-2, and 4-charge in FIG. 5 are repeatedly used in order. For example, in FIG. 9, the battery 4-charge charged in FIG. 5 becomes the fully charged battery 4-full and is inserted into the holding unit 2-1. Instead, the battery 4-1 that has originally been inserted into the holding unit 2-1 is charged outside.

Further, in FIG. 10, the battery 4-2 continues to execute power supply, the remaining amount of the battery 4-2 will be eventually reduced. At this time, the battery 4-2 is replaced with the battery 4-1 charged outside.

In this way, the state in which “two batteries 4 are inserted into the power source device 100 in order and the remaining one battery 4 is charged” is constantly realized. That is, all the batteries 4 are evenly used for power supply and charging, and no battery 4 deteriorates extremely quickly.

It goes without saying that power supply may be executed by a method of using the battery 4 having a larger remaining amount until the remaining amount reaches 0%.

For example, in this method, in the case where the remaining amount of the battery 4-1 is 100% and the remaining amount of the battery 4-2 is 50%, the battery 4-1 having a larger remaining amount is selected as the power supply battery 7 and is used for power supply until the remaining amount reaches 0%.

The battery 4-1 whose remaining amount is 0% is replaced with, for example, the fully charged battery 4-full (referred to as the battery 4-3). Since the remaining amount of the fully charged battery 4-3 is larger than that of the battery 4-2, the replaced fully charged battery 4-3 is selected as the power supply battery 7 and is used for power supply until the remaining amount reaches 0%.

Further, the battery 4-3 whose remaining amount is 0% is replaced with, for example, the charged battery 4-1 and the battery 4-1 is selected as the power supply battery 7 again and executes power supply.

In this way, the power supply by the power source device 100 is realized.

However, in this case, power supply by the battery 4-2 is never executed. That is, the battery 4 that is not used for power supply is present in the power source device 100.

Therefore, there is also a possibility that the efficiency for using the battery 4 slightly decreases.

By executing power supply by the battery 4 having a smaller remaining amount as in this embodiment, the above situation can be avoided and more efficient use of the battery 4 can be realized.

In addition, the method of selecting the power supply battery 7 by the power control unit 5 is not limited.

For example, in addition to the selection method based on the remaining amount of the battery 4 described above, the power supply battery 7 may be selected on the basis of the state of the battery 4 such as the decrease in the remaining amount of the battery 4, the temperature of the battery 4, and the presence or absence of power supply by the battery 4.

In the case where the power supply battery 7 is selected on the basis of the decrease in the remaining amount of the battery 4, for example, the battery 4 determined to have “a decrease in the remaining amount of” is selected. That is, the power supply by the battery 4 having a smaller remaining amount is controlled.

Further, in the case where the power supply battery 7 is selected on the basis of the temperature of the battery 4, for example, the battery 4 having the lowest temperature is selected. As a result, the battery 4 is safely operated.

Further, in the case where the power supply battery 7 is selected on the basis of the presence or absence of power supply by the battery 4, for example, it is possible to perform control such that the battery 4 without power supply is newly selected as the power supply battery 7.

Further, for example, the power control unit 5 may select a plurality of power supply batteries 7.

The method of selecting the plurality of power supply batteries 7 is not limited. For example, the battery 4 may be selected as an arbitrary method such as “selecting two batteries 4 in descending order of the remaining amount” and “selecting three batteries 4 in descending order of temperature”.

This enables flexible selection of the power supply battery 7.

Further, the power supply battery 7 may be selected by a user's instruction.

For example, the remaining amounts and the like of the batteries 4 held by the respective holding units 2-1 to 2-n are displayed on a device such as the touch panel 9 that functions as the notification unit 6, a display unit, and an operation input unit.

The power supply battery 7 may be selected on the basis of an operation of selecting the battery 4 input to the touch panel 9.

This enables efficient selection of the power supply battery 7 based on the user's determination.

### [Notification to User]

Variations in the content of notification by the notification unit 6 will be described.

In this embodiment, the notification unit 6 notifies a user of at least one of the remaining amount of the battery 4, the decrease in the remaining amount of the battery 4, the temperature of the battery 4, or the presence or absence of the power supply by the battery 4.

Specifically, the power control unit 5 detects at least one of the remaining amount of the battery 4, the decrease in the remaining amount of the battery 4, the temperature of the battery 4, or the presence or absence of the power supply by the battery 4. The notification unit 6 is capable of notifying the user of the information described above by acquiring the information detected by the power control unit 5.

In the case where the remaining amount of the battery 4 is notified, for example, information indicating that “the remaining amount of the battery 4 is 50%” is displayed on the touch panel 9. Alternatively, it is output from the speaker 11 as audio. That is, notification of information is executed.

This allows the user to know the remaining amount of the battery 4. For example, it is possible to determine, on the basis of the remaining amount of the battery 4, whether or not the battery 4 is to be charged.

In the case where a decrease in the remaining amount of the battery 4 is notified, a threshold value (e.g., 30%) set in advance and the remaining amount of the battery 4 are compared with each other. In the case where the remaining amount is below the threshold value, notification of information indicating that “the remaining amount of the battery 4 is low”, or the like is executed.

Meanwhile, in the case where the remaining amount exceeds the threshold value, information indicating that “the remaining amount of the battery 4 is sufficient”, or the like may be notified. No notification to the user may be executed.

In this case, the threshold value used for determining a decrease in the remaining amount is not limited.

This allows the user to know the decrease in the remaining amount of the battery 4. For example, in the case where the remaining amount of the battery 4 is low, the battery 4 can be replaced in advance before the remaining amount reaches 0%.

The method of detecting the decrease in the remaining amount is not limited, and an arbitrary method may be adopted.

In the case where the temperature of the battery 4 is notified, for example, a temperature sensor is disposed in the vicinity of the battery 4, e.g., on the holding unit 2, and the temperature is acquired. Further, information indicating that “the temperature of the battery 4 is 40° C.”, or the like is notified.

As the temperature sensor, for example, a well-known one such as a thermistor may be used.

In the case where the temperature is high and there is a possibility that the driving of the power source device 100 and the electronic apparatus is adversely affected, a warning indicating that “the battery 4 is hot”, “please detach the battery 4”, or the like may be issued.

This allows the user to know the temperature of the battery 4. For example, it is possible to detach, in the case where the temperature of the battery 4 is high, the battery 4 for safety.

The method of detecting the temperature of the battery 4 is not limited, and an arbitrary method may be adopted.

In the case where the presence or absence of power supply by the battery 4 is notified, for example, the power control unit 5 monitors whether or not a current is flowing through the circuit and determines the presence or absence of power supply. Further, for example, information indicating that “the battery 4 is supplying power”, or the like is notified.

This allows the user to know the presence or absence of power supply by the battery 4. For example, in the case where there is the battery 4 that is not used for power supply, this battery 4 can be detached and charged.

The method of detecting the presence or absence of power supply by the battery 4 is not limited, and an arbitrary method may be adopted.

Further, in this embodiment, the notification unit 6 notifies a user of whether or not the battery 4 is held for each of the plurality of holding units 2-1 to 2-n.

Specifically, the power control unit 5 detects whether or not the battery 4 is held for each of the plurality of holding units 2-1 to 2-n. The notification unit 6 is capable of notifying the user of whether or not the battery 4 is held by acquiring whether or not the battery 4 is held detected by the power control unit 5.

Whether or not the battery 4 is held means whether or not the battery 4 is inserted into (placed on) the holding unit 2. That is, the state in which the battery 4 is inserted into the holding unit 2 corresponds to holding. Further, the state in which the battery 4 is not inserted into the holding unit 2 corresponds to no holding.

For example, a pressure-sensitive sensor is provided in the holding unit 2 and detects an increase in pressure due to contact when the battery 4 is inserted. As a result, the insertion of the battery 4 into the holding unit 2 is detected. That is, the power control unit 5 detects “holding”.

In this case, for example, information indicating that “the battery 4 is inserted in the holding unit 2”, or the like is notified.

Further, in the case where “no holding” is detected, information indicating that “the battery 4 is not inserted in the holding unit 2”, or the like may be notified.

This allows the user to know in which holding unit 2 the battery 4 is inserted. For example, in the case where there is the holding unit 2 in which the battery 4 is not inserted, the battery 4 is inserted into the holding unit 2, which enables efficient use of the power source device 100.

The method of detecting whether or not the battery 4 is held is not limited, and an arbitrary method may be adopted.

As described above, the notification unit 6 notifies a user of various types of information.

It goes without saying that the information to be notified is not limited to the examples described above, and arbitrary information may be notified.

Further, the information acquired by the notification unit 6 may be notified to an OS (Operating System) installed in the power source device 100 and the OS may control various operations of the power source device 100 on the basis of the notified information,

Further, instead of the electronic apparatus, the power source device 100 itself may include the touch panel 9 and the speaker 11, and notification may be made by the touch panel 9 and the speaker 11 of the power source device 100.

For example, in the case where the power source device 100 is attached externally instead of being built in the electronic apparatus, the touch panel 9 and the speaker 11 are formed in the power source device 100 itself.

### [Variations in Power Supply]

Variations in the power supply method, i.e., variations in the control method of power supply by the power control unit 5 will be described below.

For example, the power control unit 5 may select a plurality of power supply batteries 7 and control the speed of power supply of each of the plurality of power supply batteries 7.

The speed of power supply can be defined as, for example, the amount of electric power supplied by the battery 4 per unit time. It goes without saying that the present technology is not limited to such definition.

For example, the speed is weighted, e.g., “the speed of power supply by the battery 4-1 is twice the speed of power supply by the battery 4-2”, and symmetric power supply is executed.

Specifically, the power control unit 5 is capable of controlling the speed of power supply by controlling various mechanisms such as a capacitor included in the circuit.

This enables a flexible operation of the battery 4, e.g., control is executed such that the speed of power supply increases for the battery 4 having a large capacity (amount of electric power that can be stored).

Further, control may be performed such that the power control unit 5 selects a plurality of power supply batteries 7 and the speeds of power supply of the respective plurality of power supply batteries 7 are the same speed.

As a result, the respective batteries 4 are evenly used and no battery 4 deteriorates extremely quickly.

Further, the power control unit 5 may select a plurality of power supply batteries 7 and control the power supply such that the remaining amounts of the respective plurality of power supply batteries 7 are the same.

For example, the power supply is controlled such that the remaining amounts are the same, e.g., the remaining amounts of both the two batteries 4-1 and 4-2 are 80%.

Further, for example, in the case where the remaining amounts of the respective batteries 4 are different from each other when the operation of the power source device 100 is started, the remaining amounts may be adjusted to be the same by executing power supply by the battery 4 having a larger remaining amount. For example, in the case where the remaining amount of the battery 4-1 is 80% and the remaining amount of the battery 4-2 is 50%, power supply by only the battery 4-1 is executed first and power supply by both the batteries 4-1 and 4-2 is started at the moment when the remaining amount of the battery 4-1 was reduced to 50%.

As a result, the timing at which each of the batteries 4 needs to be replaced (e.g., when the remaining amount reached 10%) is the same, and thus, the batteries 4 can be collectively replaced. That is, the user's time and effort for replacing the battery 4 is reduced.

Further, the power control unit 5 may stop the power supply by the power supply battery 7 whose remaining amount is smaller than a predetermined threshold value.

The threshold value is the lower limit of the battery remaining amount for supplying power from the battery 4. For example, in the case where the threshold value is set to “5%”, the power supply is executed in the case where the remaining amount of the battery 4 is 5% or more and the power supply by the battery 4 is stopped in the case where the remaining amount of the battery 4 is smaller than 5%.

Note that the threshold value is not limited to a specific value and may be set to an arbitrary value.

As a result, it is possible to prevent the battery 4 from deteriorating due to overdischarge.

Further, the power control unit 5 may select a plurality of power supply batteries 7, and in the case where the remaining amounts of the respective plurality of power supply batteries 7 are smaller than a predetermined threshold value, another battery 4 whose remaining amount is larger than the predetermined threshold value may be switched to the power supply battery 7.

For example, power supply by the battery 4-1 and the battery 4-2 selected as the power supply batteries 7 is executed, and the power supply by both the batteries 4-1 and 4-2 is stopped at the moment when the remaining amounts of both the batteries 4-1 and 4-2 became smaller than 5%. At the same time, another battery 4-3 whose remaining amount is larger than 5% is selected as the power supply battery 7 and power supply by the battery 4-3 is newly started.

In this way, switching of the power supply battery 7 is executed.

In this embodiment, for example, whether or not the remaining amount of the battery 4 is below a threshold value is determined at a predetermined frame rate.

As a result, it is possible to maintains the power supply by the power source device 100 while preventing the battery 4 from deteriorating due to overdischarge.

Further, the power control unit 5 may select a plurality of power supply batteries 7, and in the case where the remaining amounts of the respective plurality of power supply batteries 7 are smaller than a predetermined threshold value and another battery 4 whose remaining amount is larger than the predetermined threshold value is not present, power supply by the plurality of batteries 4-1 to 4-n held by the plurality of holding units 2-1 to 2-n may be executed.

For example, in the case where power supply by the battery 4 whose remaining amount is larger than 5% is executed in order and the remaining amounts of all the batteries 4 held by the holding units 2 fall below 5%, power supply by one of the batteries 4 is newly started.

This enables a flexible operation of the battery 4, e.g., setting of the threshold value is temporarily released and power supply is possible in the case where there is a possibility that power supply by all the batteries 4 is stopped, while normally preventing the battery 4 from deteriorating due to overdischarge.

The method of controlling power supply by the power control unit 5 as described above may be changeable in accordance with the state of the battery 4 and the state of the electronic apparatus on which the power source device 100 is mounted.

Further, the method of controlling power supply is not limited to the examples described above, and an arbitrary method may be adopted.

### [Electric Power Exchange]

In this embodiment, the power control unit 5 is configured to be capable of exchanging electric power between the plurality of batteries 4-1 to 4-n held by the plurality of holding units 2-1 to 2-n.

That is, electric power can be exchanged between the plurality of batteries 4. For example, it is possible to move electric power from the battery 4-1 to the battery 4-2. Further, electric power may be changeable between three or more batteries.

Specifically, the power control unit 5 controls a mechanism such as a capacitor included in the circuit to realize electric power exchange.

For example, the power control unit 5 concentrates electric power to one battery 4 of the plurality of batteries 4-1 to 4-n held by the plurality of holding units 2-1 to 2-n.

For example, in the case where the battery 4-1 whose remaining amount is 10 and the battery 4-2 whose remaining amount is 30%, which have the same capacity, are held, electric power is concentrated to the battery 4-2. That is, electric power corresponding to the amount of 10% is supplied from the battery 4-1 to the battery 4-2. After the concentration, the remaining amount of the battery 4-1 is 0%, and the remaining amount of the battery 4-2 is 40%.

This enables efficient charging by replacing the battery 4. For example, by replacing the battery 4-1 whose remaining amount is 0% after concentrating electric power, it is possible to significantly increase the battery remaining amount of the entire power source device 100.

Further, the power control unit 5 may exchange electric power such that the remaining amounts of the respective plurality of batteries 4-1 to 4-n held by the plurality of holding units 2-1 to 2-n are the same.

For example, in the case where the battery 4-1 whose remaining amount is 10 and the battery 4-2 whose remaining amount is 30% are held, electric power is exchanged such that the respective remaining amounts are the same. That is, electric power corresponding to the amount of 10% is supplied from the battery 4-2 to the battery 4-1. Therefore, the remaining amounts of the respective batteries 4-1 and 4-2 are both 20%.

As a result, it is possible to efficiently share the battery 4 between power source devices 100.

The sharing of the battery 4 means exchanging the battery 4 between the power source devices 100. For example, a user detaches one battery 4 from each of the power source devices 100, exchanges the respective batteries 4, and inserts them into the power source devices 100, thereby realizing the sharing.

Specifically, for example, for two power source devices 100, the sharing makes it possible to match the battery remaining amounts of the entire power source devices 100.

For example, the battery 4 is shared between a power source device in which the battery 4-1 (remaining amount of 70%) and the battery 4-2 (remaining amount of 50%) are inserted (referred to as a power source device A) and a power source device in which the battery 4-3 (remaining amount of 60%) and the battery 4-4 (remaining amount of 20% are inserted (referred to as a power source device B).

In this case, first, electric power is exchanged in the power source devices 100 such that the remaining amounts of the batteries 4 inserted in the respective power source devices 100 are the same.

That is, by exchanging electric power, the remaining amounts of the battery 4-1 and the battery 4-2 inserted in the power source device A are both 60%. Further, the remaining amounts of the battery 4-3 and the battery 4-4 inserted in the power source device B are both 40%.

In this state, sharing of the battery 4 is executed. For example, the battery 4-1 inserted in the power source device A and the battery 4-3 inserted in the power source device B are replaced with each other. After the replacement, the battery 4-3 (remaining amount of 40%) and the battery 4-2 (remaining amount of 60%) are inserted in the power source device A. Further, the battery 4-1 (remaining amount of 60%) and the battery 4-4 (remaining amount of 40%) are inserted in the power source device B.

That is, in each of the power source device A and the power source device B, the battery remaining amount of the entire power source device 100 is 50%.

In this way, when electric power can be exchanged such that the remaining amounts of the respective batteries 4 are the same, it is possible to match the battery remaining amounts of the entire power source devices 100 by sharing.

It goes without saying that the sharing of the battery 4 may be executed as it is without exchanging electric power such that the remaining amounts of the batteries 4 inserted in the power source device 100 are the same in advance.

That is, for example, in the example described above, the battery 4-1 (remaining amount of 70%) inserted in the power source device A and the battery 4-3 (remaining amount of 60%) inserted in the power source device B may be replaced as they are without exchanging electric power in the respective power source devices 100.

In this case, after the exchange, the battery 4-3 (remaining amount of 60%) and the battery 4-2 (remaining amount of 50%) are inserted in the power source device A. Further, the battery 4-1 (remaining amount of 70%) and the battery 4-4 (remaining amount of 20%) are inserted in the power source device B. That is, the battery remaining amount of the entire power source device A is 55%, and the battery remaining amount of the entire power source device B is 45%.

Further, before executing sharing, electric power may be concentrated to one battery 4 in each of the power source devices 100.

These sharing methods realize asymmetrical exchange of electric power between a plurality of power source devices 100 and make it possible to adjust the battery remaining amounts of the entire power source devices 100 to a desired value.

That is, for example, it is possible to flexibly operate the power source device 100, e.g., the battery remaining amount of the entire power source device 100 is adjusted to a desired value by sharing in accordance with the frequency of using the electronic apparatus.

In addition, the method of exchanging electric power by the power control unit 5 is not limited to the example described above, electric power may be exchanged by an arbitrary method.

### [Variations in Charging]

In this embodiment, electric power may be supplied from an external power source to the power source device 100 via a charging adaptor or the like, and the battery 4 inserted in the power source device 100 may be charged.

Alternatively, a charging adaptor may be connected to the electronic apparatus in which the power source device 100 is built to charge the battery 4.

In this case, the power control unit 5 controls charging of each of the plurality of batteries 4-1 to 4-n held by the plurality of holding units 2-1 to 2-n.

Specifically, the charging is controlled by the power control unit 5 controlling mechanisms such as a capacitor of the circuit.

Variations in the charging method, i.e., the control method of charging by the power control unit 5, will be described below.

For example, the power control unit 5 controls the charging speed of each of the plurality of batteries 4-1 to 4-n held by the plurality of holding units 2-1 to 2-n.

The charging speed can be defined as, for example, the amount of electric power to be supplied to the battery 4 per unit time. It goes without saying that the present technology is not limited to such a definition.

For example, the speed is weighted, e.g., “the charging speed of the battery 4-1 is twice the charging speed of the battery 4-2”, and charging is executed.

This enables a flexible operation of the battery 4, e.g., control is executed such that the charging speed of the battery 4 having a larger capacity (amount of electric power that can be stored) is increased.

Further, the power control unit 5 may control the speed of charging of each of the plurality of batteries 4-1 to 4-n held by the plurality of holding units 2-1 to 2-n to be the same speed.

As a result, the respective batteries 4 are evenly used, and no battery 4 deteriorates extremely quickly.

Further, the power control unit 5 may control the charging such that the remaining amounts of the plurality of batteries 4-1 to 4-n held by the plurality of holding units 2-1 to 2-n are the same.

For example, the charging is controlled such that the remaining amounts are the same, e.g., the remaining amount of each of the battery 4-1 and the battery 4-2 is 80%.

Further, for example, in the case where the remaining amounts of the respective batteries 4 differ when charging is started, the respective remaining amounts may be adjusted to be the same by supplying power to the battery 4 whose remaining amount is low. For example, in the case where the remaining amount of the battery 4-1 is 80% and the remaining amount of the battery 4-2 is 50%, only the battery 4-2 is charged first and charging of both the batteries 4-1 and 4-2 is started at the moment when the remaining amount of the battery 4-2 reached 80%.

As a result, charging is executed while the remaining amounts of the batteries 4 are the same, and thus, it is possible to efficiently perform sharing of the battery 4.

Further, the power control unit 5 may stop the charging of the battery 4 whose remaining amount is larger than a predetermined threshold value.

The threshold value is the upper limit of the battery remaining amount for charging the battery 4. For example, in the case where the threshold value is set to “95%”, the battery 4 is charged in the case where the remaining amount of the battery 4 is 95% or less. Further, in the case where the remaining amount of the battery 4 exceeds 95%, the charging of the battery 4 is stopped.

Note that the threshold value is not limited to a specific value and may be set to an arbitrary value.

As a result, it is possible to prevent the battery 4 from deteriorating due to overcharging.

Further, the power control unit 5 may switch, in the case where the remaining amounts of the plurality of batteries 4-1 to 4-n held by the plurality of holding units 2-1 to 2-n exceed a predetermined threshold value, the charging to another battery 4 whose remaining amount is smaller than the predetermined threshold value.

For example, the battery 4-1 and the battery 4-2 are charged and the charging of both the batteries 4-1 and 4-2 is stopped at the moment when the remaining amounts of both the batteries 4-1 and 4-2 exceeded 95%. At the same time, charging of the battery 4-3 whose remaining amount is smaller than 95% is newly started.

In this way, switching of charging is executed.

In this embodiment, for example, whether or not the remaining amount of the battery 4 exceeds a threshold value is determined at a predetermined frame rate.

As a result, it is possible to maintain the charging of the battery 4 while preventing the battery 4 from deteriorating due to overcharging.

Further, the power control unit 5 may supply, in the case where the remaining amounts of the plurality of batteries 4-1 to 4-n held by the plurality of holding units 2-1 to 2-n exceed a predetermined threshold value and there is no other battery 4 whose remaining amount is smaller than the predetermined threshold value, power to the plurality of batteries 4-1 to 4-n held by the plurality of holding units 2-1 to 2-n.

For example, the battery 4 whose remaining amount is smaller than 95% is charged in order, and in the case where the remaining amounts of all the batteries 4 exceed 95%, charging of any battery 4 is newly started.

This enables efficient charging, e.g., setting of the threshold value is temporarily released and charging is possible in the case where there is no battery 4 to be charged, while normally preventing the battery 4 from deteriorating due to overcharging.

Further, the power control unit 5 may charge one of the plurality of batteries 4-1 to 4-n held by the plurality of holding units 2-1 to 2-n.

In this case, for example, one battery 4 to be charged is selected on the basis of the state of the battery 4, e.g., “the battery 4 having the lowest remaining amount” and “the battery 4 having the lowest temperature”.

As a result, the one battery 4 is charged intensively. That is, it is possible to complete charging in a short time.

The control method of charging by the power control unit 5 as described above may be changeable depending on the state of the battery 4 and the state of the electronic apparatus on which the power source device 100 is mounted.

Further, the control method of charging is not limited to the example described above, and an arbitrary method may be adopted.

Further, in the case where a charging cable is connected to the electronic apparatus, electric power may be directly supplied to the electronic apparatus without charging the battery 4. As a result, it is possible to suppress the influence of exhaust heat generated when the battery 4 is charged on the terminal.

### [Electronic Apparatus]

Although the mobile terminal 8 has been illustrated as an example of an electronic apparatus to which the power source device 100 can be applied in FIG. 5 and the like, the present technology is not limited thereto and is applicable to various electronic apparatuses.

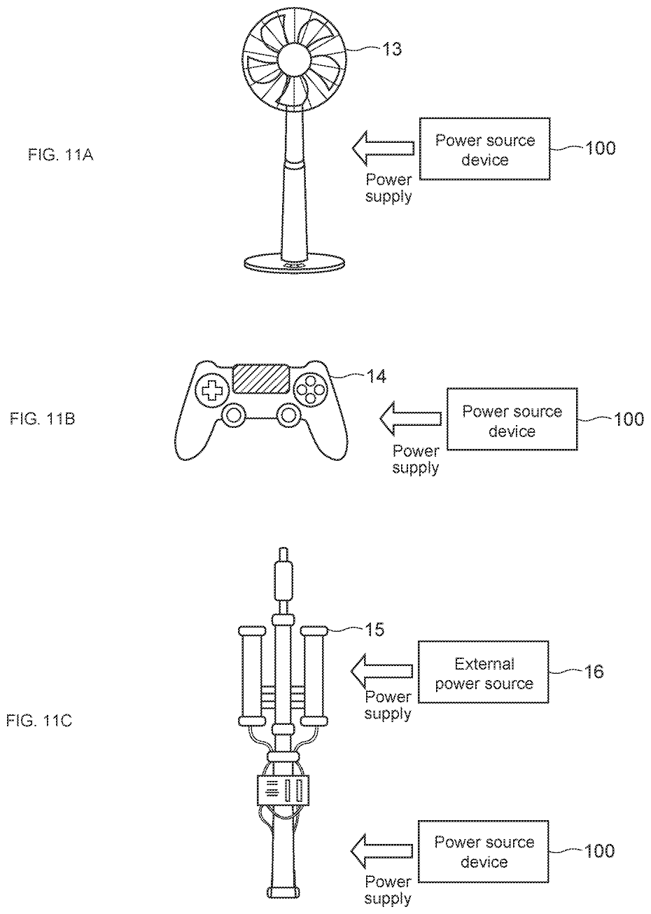

FIG. 11 is a schematic diagram showing an example of an electronic apparatus to which the power source device 100 can be applied.

Part A of FIG. 11 shows a schematic diagram of a fan as an electronic apparatus in which a power source device can be built.

Further, Part B of FIG. 11 shows a schematic diagram of a game controller.

Further, Part C of FIG. 11 shows a schematic diagram of a communication base station.

In the example shown in Part A of FIG. 11, the power source device 100 is built in a fan 13 and electric power is supplied from the power source device 100 to the fan 13. This realizes, for example, an operation such as rotation of a blade.

Note that the power source device 100 may be built in the fan 13 at an arbitrary position.

The fan 13 corresponds to an embodiment of an electronic apparatus according to the present technology.

Further, for example, a control unit, a motor, a blade, and the like of the fan 13 correspond to an embodiment of a functional part unit according to the present technology.

For example, a configuration in which a power cable is attached to the fan 13, electric power is supplied by connecting the cable to a household outlet, and the fan 13 operates is conceivable. In the case of such a fan 13, the fan 13 can be installed only within a range in which the cable can be stretched. That is, the installation range of the fan 13 is limited, which is inconvenient for the user.

Meanwhile, in accordance with the present technology, since no cable is attached to the fan 13, the installation location is not limited. That is, it is expected to be used in places where it could not be installed before, such as outdoors and bathrooms.

In the example shown in Part B of FIG. 11, the power source device 100 is built in a game controller 14 capable of performing wireless communication. That is, a cable such as a power cable and a connection cable to the game console body is not connected to the controller 14.

Acquisition of a user's input operation, transmission of radio waves, and the like are realized by power supply from the power source device 100.

The controller 14 corresponds to an embodiment of an electronic apparatus according to the present technology.

Further, for example, the control unit, the communication unit, and the like of the controller 14 corresponds to an embodiment of a functional part unit according to the present technology.

For example, there may be a configuration in which the controller 14 capable of performing wireless communication is charged using a charging cable. In this case, in the case where a user uses the controller 14 being charged, the movable range of the controller 14 is limited, which is inconvenient for the user.

In accordance with the present technology, since the connection of a charging cable is unnecessary, it is possible to prevent the deterioration of mobility that occurs during charging. That is, it can be expected that deterioration of UX (User Experience) due to wired connection during charging can be suppressed.

In the example shown in Part C of FIG. 11, the power source device 100 is built in a communication base station 15.

In this example, the power source device 100 is built in the base station 15 as an emergency power source. That is, an external power source 16 supplies electric power to the base station 15 normally, and in the case where the supply of electric power is interrupted due to a power outage or the like, power supply by the power source device 100 (emergency power source) is started.

For example, the power source device 100 supplies electric power to the antenna, the control unit, and the like of the base station 15.

The base station 15 corresponds to an embodiment of an electronic apparatus according to the present technology.

Further, for example, the control unit, the antenna, and the like of the base station 15 correspond to an embodiment of a functional part unit according to the present technology.

For example, in the case where an earthquake occurs, large-scale power outages (blackouts) often occur over a wide area. In such a case, the communication base station 15 is capable of operating with an emergency power source, but the emergency power source cannot be charged without power supply from a power plant. For this reason, an emergency situation in which the operation of the base station 15 eventually stops and the communication network is cut off can occur.

In accordance with the present technology, by replacing the battery of the power source device 100 (emergency power source), it is possible to continue operating the base station 15 even during a power outage. For example, by transporting the battery 4 by land and replacing the battery 4, the function of the base station 15 can be maintained semi-permanently, which is effective in an emergency.

Further, for example, the power source device 100 can also be built in a component stereo used at, an outdoor event or the like.

Normally, a generator filled with gasoline is prepared and connected to the component stereo to operate the component stereo.

In accordance with the present technology, it is possible to operate the component stereo on the spot simply by preparing the battery 4 and it is expected to be used in wider variety of situations.

Note that in this embodiment, three or more batteries 4 may be installable in the power source device 100. That is, the plurality of holding units 2-1 to 2-n may be three or more holding units.

The installation of the three or more batteries 4 is particularly effective in the case where the power source device 100 is applied to a compact electronic apparatus such as the game controller 14.

For example, in the case where the total capacity of the batteries 4 to be built in the electronic apparatus is determined, each battery 4 is miniaturized by distributing the batteries 4 in a large number.

As a result, even in the case where the electronic apparatus is compact, it is possible to install the battery 4 in a small gap.

Further, also by laying out as many batteries 4 as possible in the empty space of the electronic apparatus, it is possible to increase the total capacity of the batteries 4.

Further, the plurality of holding units 2-1 to 2-n may be configured to be capable of holding the respective plurality of batteries 4-1 to 4-n of different types.

That is, the types of the respective batteries 4 may differ.

Examples of the types of the batteries 4 include batteries such as a lithium polymer battery, a nickel-cadmium battery, a lead-acid batter, and an alkaline-acid battery in addition to the above-mentioned lithium ion battery and all-solid battery. The present technology is not limited thereto, and an arbitrary combination of different types of batteries 4 may be adopted.

Further, the shapes of the respective batteries 4 may differ.

For example, it is possible to combine and use a plurality of batteries 4 of the same type but different sizes due to different capacities.

This increases the degree of freedom in the type and shape of the battery 4, and the power source device 100 can be made applicable to various devices.

Note that the electronic apparatus to which the power source device 100 can be applied is not limited to the example shown in FIG. 11.

For example, the power source device 100 is applicable to a drier. In this case, electric power supplied from the power source device 100 realizes the blowing operation of the drier.

In this way, the electronic apparatus is capable of realizing a predetermined operation by using the supplied electric power.

In addition, the present technology is applicable to an arbitrary electronic apparatus such as an earphone, a headphone, a tablet terminal, a wearable device, a personal computer, a game console, a digital camera, an audio device, a TV, a projector, a car navigation system, a clock, a remoter control, and an IoT device connected to the Internet or the like.

As described above, in the power source device 100 according to this embodiment, the power supply battery 7 is selected on the basis of the state of each of the plurality of batteries 4-1 to 4-n attachably/detachably held by the plurality of holding units 2-1 to 2-n. Further, the other batteries 4 that have not been selected as the power supply battery 7 are attachable/detachable to/from the holding units while power supply from the power supply battery 7 is maintained. This enables efficient charging.

A mobile terminal such as a smartphone and a tablet is now used in every aspect of daily lives. The applications thereof range from recreational applications such as viewing a moving image and playing a game to business applications such as use as a means of communication between employees outside the company and incorporation into an anomaly detection system in factories.

In these applications, the mobile terminal is basically used in a state disconnected from an external power source and operates using a battery as a power source. For this reason, the user needs to charge the mobile terminal in a timely manner. In this case, it is necessary to fix the position of the mobile terminal, e.g., connect the terminal to an external power source by using a charging cable or disposing the terminal near a wireless power supply device. For this reason, in the case of charging the mobile terminal, the mobility that is the advantage of the mobile terminal is reduced and the user feels inconvenient.

In accordance with the present technology, by replacing the battery, it is possible to perform pseudo-instantaneous charging and avoid the restrictions on the mobility of the mobile terminal that occur during charging.

Further, in recent years, in order to realize large-capacity, low-delay, and multi-connection communication, a shift from 4G to 5G is underway. The 5G communication is divided into a Sub6 band that uses 3.6 to 6 GHZ and a millimeter wave band that uses 30 to 300 Ghz band.

In the 5G communication, it is known that the power consumption increases as compared with the 4G communication, particularly when using millimeter waves. The reason for this is that, for example, in the 5G millimeter wave communication, a plurality of antennas is simultaneously used to establish communication and thus, the power consumption increases by the amount corresponding to the additional antenna modules. In addition, since a large amount of data is exchanged instantaneously, power consumption is assumed to increase by the amount corresponding to the increased data processing. For this reason, in order to stably use the 5G millimeter wave communication, it is important to increase the battery capacity of the terminal or further improve the charging speed. However, the terminal using the 5G millimeter wave communication is expected to have a problem of higher terminal temperatures due to their high power consumption.

In the case where the temperature of the terminal is high, assumption is made that charging of the battery is performed at a low speed or not performed at all for safety reasons.

In the present technology, since charging is performed by replacing the battery with the battery 4 that has been changed in advance, the mobile terminal 8 is not used while being charged and the generation of heat can be avoided. For this reason, the thermal runaway and failure of the terminal can be suppressed.

Further, since the user can easily replace the battery 4, it is possible to easily deal with exhaustion of the battery 4 and improve the lifetime of the mobile terminal 8.

Further, for example, in a power source device that cannot be hot-swapped, such as a power source device including only one battery, the power supply by the power source device is stopped while the battery is replaced by the user. That is, in the case where a power source device is built in an electronic apparatus, the operation of the electronic apparatus is stopped.

Therefore, the user needs to perform, when replacing the battery, a procedure of turning off the power source by pressing the power button or the like of the electronic apparatus, then replacing the battery, and turning on the power source again after the replacement. That is, the procedure of the battery replacement becomes complicated for the user.

Further, since the operation of the electronic apparatus is stopped during the battery replacement, there is also a problem that it is inconvenient for the user. For example, if the operation of the clock is stopped, not only the time cannot be known during the battery replacement but also it is troublesome to need to correct the time that has shifted due to the stop of the operation.

Since the power source device 100 according to this embodiment can be hot-swapped, the user can easily replace the battery 4 without causing the above-mentioned problem.

### Other Embodiments

The present technology is not limited to the embodiment described above and can realize various other embodiments.

The power control unit 5 may restrict, in the case where the battery 4 is held by only one of the plurality of holding units 2-1 to 2-n, the detachment of the battery 4 from the one holding unit.

If the battery 4 is erroneously detached when only one battery 4 is inserted, the power supply by the power source device 100 is stopped. As a result, the operation of the electronic apparatus is stopped unintentionally for the user.

In order to prevent such a situation, in the case where only one battery 4 is inserted, the one battery 4 is fixed so as not to be detached.

The restriction of detachment is executed by, for example, controlling the above-mentioned lock mechanism by the power control unit 5.

In the case where the power control unit 5 has detected that the number of batteries 4 held by the holding unit 2 is one, the slider of the lock mechanism is fixed so that it cannot be moved by the user. Further, in the case where it has been detected that the number of held batteries 4 is two or more, the fixation is released.

This prevents, for example, the user from mistakenly thinking that a plurality of batteries 4 is inserted and detaching the battery. Alternatively, it is possible to prevent the battery 4 from popping out when the power source device 100 is hit against another object. Therefore, it is possible to prevent the operation of the electronic apparatus from being stopped unintentionally for the user.

A case where the electronic apparatus and the power source device 100 are integrated and are not distinguished from each other is also included in the scope of the present technology.

That is, for example, even if the power source device 100 does not include a base portion (box-shaped casing or the like), the entire mechanism that is built in the electronic apparatus and realizes the function of the power source device 100 can be called the power source device 100 according to the present technology.

The present technology may be applied to power supply between devices using wireless power supply.

The wireless power supply is a power supply method of supplying electric power without using cables or plugs. Specifically, for example, a power transmission coil and a power reception coil are used to execute power transmission.

For example, wireless power supply may be used to execute the above-mentioned exchange of electric power between the batteries 4 inserted in difference devices.

In addition, an arbitrary technology described in the present disclosure may be applied to power supply between devices using the wireless power supply.

The respective configurations of the power source device, the mobile terminal, the electronic apparatus, and the like described with reference to the drawings, the processing flow, and the like are merely an embodiment, and can be arbitrarily modified without departing from the essence of the present technology. That is, another arbitrary configuration, algorithm, and the like for implementing the present technology may be adopted.

In the present disclosure, when the word “substantially” is used, it is used only for the purpose of facilitating the understanding of the description and the use/non-use of the word “substantially” does not have a special meaning.

That is, in the present disclosure, concepts that define shapes, sizes, positional relationships, states, and the like, such as “central”, “middle”, “uniform”, “equal”, “same”, “orthogonal”, “parallel”, “symmetric”, “extended”, “axial direction”, “columnar shape”, “cylindrical shape”, “ring shape”, and “annual shape”, are concepts including “substantially central”, “substantially middle”, “substantially uniform”, “substantially equal”, “substantially the same”, “substantially orthogonal”, “substantially parallel”, “substantially symmetric”, “substantially extended”, “substantially axial direction”, “substantially columnar shape”, “substantially cylindrical shape”, “substantially ring shape”, and “substantially annual shape”.

For example, a state included in a predetermined range (e.g., a range of +10%) with reference to “completely central”, “completely middle”, “completely uniform”, “completely equal”, “completely the same”, “completely orthogonal”, “completely parallel”, “completely symmetrical”, “completely extended”, “completely axial direction”, “completely columnar shape”, “completely cylindrical shape”, “completely ring shape”, “completely annular shape”, and the like is also included.

Therefore, even in the case where the word “substantially” is not added, a concept expressed by adding a so-called “substantially” can be included. On the contrary, the complete state is not excluded from the state expressed by adding “substantially”.

In the present disclosure, expressions using “than” such as “larger than A” and “smaller than A” comprehensively include both the concept including the case where it is equivalent to A and the concept not including the case where it is equivalent to A. For example, the phrase “larger than A” is not limited to the case not including being equivalent to A and includes “A or more”. Further, the phrase “smaller than A” is not limited to “less than A” and includes “A or less”.

When implementing the present technology, specific settings and the like only need to be appropriately adopted from the concepts included in “larger than A” and “smaller than A” such that the effects described above are exhibited.

Of the feature portions according to the present technology described above, at least two feature portions can be combined. That is, the various feature portions described in the respective embodiments may be arbitrarily combined with each other without distinguishing from each other in the respective embodiments. Further, the effects described above are merely illustrative and are not limitative, and other effects may be exhibited.

It should be noted that the present technology may also take the following configurations.

(1) A power source device, including:
a plurality of holding units, each of which attachably/detachably holds a battery; and
a power control unit that selects, on the basis of a state of each of a plurality of batteries held by the plurality of holding units, a power supply battery to be used for power supply,
the power source device being configured such that another battery that has not been selected as the power supply battery is attachable/detachable to/from the holding unit while power supply by the power supply battery is maintained.
   (2) The power source device according to (1), in which
Each of the plurality of holding units is configured such that the battery is attachable/detachable by a user.
   (3) The power source device according to (1) or (2), in which
the power control unit selects, as the power supply battery, a battery having the lowest remaining amount, among the plurality of batteries held by the plurality of holding units.
   (4) The power source device according to any one of (1) to (3), in which
the power control unit detects a state of each of the plurality of batteries held by the plurality of holding units.
   (5) The power source device according to (4), in which
the power control unit detects at least one of a remaining amount of a battery, a decrease in the remaining amount of the battery, a temperature of the battery, or presence or absence of power supply by the battery.
   (6) The power source device according to any one of (1) to (5), in which
the power control unit detects whether or not a battery is held for each of the plurality of holding units.
   (7) The power source device according to any one of (1) to (6), further including
a notification unit that notifies a user of a state of each of the plurality of batteries held by the plurality of holding units.
   (8) The power source device according to (7), in which
the notification unit notifies a user of whether or not a battery is held for each of the plurality of holding units.
   (9) The power source device according to any one of (1) to (8), in which
the power control unit controls power supply by the selected power supply battery.
   (10) The power source device according to (9), in which
the power control unit selects a plurality of power supply batteries and controls a speed of power supply of each of the plurality of power supply batteries.
   (11) The power source device according to (10), in which
the power control unit controls speeds of power supply by the plurality of power supply batteries to be the same speed.
   (12) The power source device according to (9), in which
the power control unit selects a plurality of power supply batteries and controls power supply such that remaining amounts of the plurality of power supply batteries are the same.
   (13) The power source device according to (9), in which
the power control unit stops power supply by the power supply battery whose remaining amount is less than a predetermined threshold value.
   (14) The power source device according to (13), in which
the power control unit selects a plurality of power supply batteries and switches, in a case where a remaining amount of each of the plurality of power supply batteries is less than a predetermined threshold value, the power supply battery to another battery whose remaining amount is larger than the predetermined threshold value.
   (15) The power source device according to (14), in which
the power control unit selects a plurality of power supply batteries and executes, in a case where a remaining amount of each of the plurality of power supply batteries is less than a predetermined threshold value and there is no battery whose remaining amount is larger than the predetermined threshold value, power supply by the plurality of batteries held by the plurality of holding units.
   (16) The power source device according to any one of (1) to (15), in which
the power control unit is configured to be capable of exchanging power among the plurality of batteries held by the plurality of holding units.
   (17) The power source device according to (16), in which
the power control unit concentrates power to one battery among the plurality of batteries held by the plurality of holding units.
   (18) The power source device according to any one of (1) to (17), in which
the power control unit controls charging of each of the plurality of batteries held by the plurality of holding units.
   (19) The power source device according to any one of (1) to (18), in which
the power control unit restricts, in a case where the battery is held by only one holding unit among the plurality of holding units, detachment of the battery from the one holding unit.
   (20) An electronic apparatus, including:
a plurality of holding units, each of which attachably/detachably holds a battery;
a power control unit that selects, on the basis of a state of each of a plurality of batteries held by the plurality of holding units, a power supply battery to be used for power supply; and
a functional part unit that operates by power supply from the power supply battery,
the electronic apparatus being configured such that another battery that has not been selected as the power supply battery is attachable/detachable to/from the holding unit while power supply by the power supply battery is maintained.
   (21) The power source device according to (7), in which
the notification unit notifies a user of at least one of a remaining amount of a battery, a decrease in the remaining amount of the battery, a temperature of the battery, or presence or absence of power supply by the battery.
   (22) The power source device according to (16), in which
the power control unit exchanges electric power such that remaining amounts of the respective plurality of batteries held by the plurality of holding units are the same.
   (23) The power source device according to (18), in which
the power control unit controls a speed of charging of each of the plurality of batteries held by the plurality of holding units.
   (24) The power source device according to (23), in which
the power control unit controls the speeds of charging of the respective plurality of batteries held by the plurality of holding units to be the same.
   (25) The power source device according to (18), in which
the power control unit controls charging such that remaining amounts of the respective plurality of batteries held by the plurality of holding units are the same.
   (26) The power source device according to (18) or any one of (23) to (25), in which
the power control unit stops charging of the battery whose remaining amount exceeds a predetermined threshold value.
   (27) The power source device according to (18), in which
the power control unit charges one battery of the plurality of batteries held by the plurality of holding units.
   (28) The power source device according to any one of (1) to (19) or (21) to (27), in which
the plurality of holding units includes three or more holding units.
   (29) The power source device according to any one of (1) to (19) or (21) to (28), in which
the plurality of holding units is configured to be capable of holding a plurality of batteries of different types.

### REFERENCE SIGNS LIST

2 holding unit
2-1 to 2-n holding unit
4 battery
4-1 to 4-n battery
4-full battery
4-charge battery
5 power control unit
6 notification unit
7 power supply battery
8 mobile terminal
9 touch panel
11 speaker
13 fan
14 controller
15 base station

1. A power source device, comprising:
a plurality of holding units, each of which attachably/detachably holds a battery; and
a power control unit that selects, on a basis of a state of each of a plurality of batteries held by the plurality of holding units, a power supply battery to be used for power supply,
the power source device being configured such that another battery that has not been selected as the power supply battery is attachable/detachable to/from the holding unit while power supply by the power supply battery is maintained.

2. The power source device according to claim 1, wherein
Each of the plurality of holding units is configured such that the battery is attachable/detachable by a user.

3. The power source device according to claim 1, wherein
the power control unit selects, as the power supply battery, a battery having the lowest remaining amount, among the plurality of batteries held by the plurality of holding units.

4. The power source device according to claim 1, wherein
the power control unit detects a state of each of the plurality of batteries held by the plurality of holding units.

5. The power source device according to claim 4, wherein
the power control unit detects at least one of a remaining amount of a battery, a decrease in the remaining amount of the battery, a temperature of the battery, or presence or absence of power supply by the battery.

6. The power source device according to claim 1, wherein
the power control unit detects whether or not a battery is held for each of the plurality of holding units.

7. The power source device according to claim 1, further comprising
a notification unit that notifies a user of a state of each of the plurality of batteries held by the plurality of holding units.

8. The power source device according to claim 7, wherein
the notification unit notifies a user of whether or not a battery is held for each of the plurality of holding units.

9. The power source device according to claim 1, wherein
the power control unit controls power supply by the selected power supply battery.

10. The power source device according to claim 9, wherein
the power control unit selects a plurality of power supply batteries and controls a speed of power supply of each of the plurality of power supply batteries.

11. The power source device according to claim 10, wherein
the power control unit controls speeds of power supply by the plurality of power supply batteries to be the same speed.

12. The power source device according to claim 9, wherein
the power control unit selects a plurality of power supply batteries and controls power supply such that remaining amounts of the plurality of power supply batteries are the same.

13. The power source device according to claim 9, wherein
the power control unit stops power supply by the power supply battery whose remaining amount is less than a predetermined threshold value.

14. The power source device according to claim 13, wherein
the power control unit selects a plurality of power supply batteries and switches, in a case where a remaining amount of each of the plurality of power supply batteries is less than a predetermined threshold value, the power supply battery to another battery whose remaining amount is larger than the predetermined threshold value.

15. The power source device according to claim 14, wherein
the power control unit selects a plurality of power supply batteries and executes, in a case where a remaining amount of each of the plurality of power supply batteries is less than a predetermined threshold value and there is no battery whose remaining amount is larger than the predetermined threshold value, power supply by the plurality of batteries held by the plurality of holding units.

16. The power source device according to claim 1, wherein
the power control unit is configured to be capable of exchanging power among the plurality of batteries held by the plurality of holding units.

17. The power source device according to claim 16, wherein
the power control unit concentrates power to one battery among the plurality of batteries held by the plurality of holding units.

18. The power source device according to claim 1, wherein
the power control unit controls charging of each of the plurality of batteries held by the plurality of holding units.

19. The power source device according to claim 1, wherein
the power control unit restricts, in a case where the battery is held by only one holding unit among the plurality of holding units, detachment of the battery from the one holding unit.

20. An electronic apparatus, comprising:
a plurality of holding units, each of which attachably/detachably holds a battery;
a power control unit that selects, on a basis of a state of each of a plurality of batteries held by the plurality of holding units, a power supply battery to be used for power supply; and
a functional part unit that operates by power supply from the power supply battery,
the electronic apparatus being configured such that another battery that has not been selected as the power supply battery is attachable/detachable to/from the holding unit while power supply by the power supply battery is maintained.
